(19) United States
(12) Patent Application Publication
(10) Pub. No.: US 2017/0161949 A1
(43) Pub. Date: Jun. 8, 2017

(54) HOLOGRAPHIC WAVEGUIDE HUD SIDE VIEW DISPLAY

(71) Applicant: GM GLOBAL TECHNOLOGY OPERATIONS LLC, DETROIT, MI (US)

(72) Inventors: THOMAS A. SEDER, WARREN, MI (US); MARK O. VANN, CANTON, MI (US); OMER TSIMHONI, WEST BLOOMFIELD, MI (US); WILLIAM L. PEIRCE, BIRMINGHAM, MI (US)

(21) Appl. No.: 14/962,024

(22) Filed: Dec. 8, 2015

(51) Int. Cl. G06T 19/00; B60R 1/00; G02B 27/01; G06F 3/01

(52) U.S. Cl. CPC G06T 19/006; G06F 3/013; B60R 1/001; G02B 27/0172; G02B 27/0179; B60R 2300/8046; B60R 2300/205; G02B 2027/0178; G02B 2027/0181; G02B 2027/0187

(57) ABSTRACT

A method of displaying augmented reality images as captured by a primary image capture device. An image is captured exterior of a vehicle by the primary image capture device. The primary image capture device capturing an image of a driver's side adjacent lane. Determining, by a processor, a size of the primary augmented reality image to be displayed to the driver. Generating a primary augmented reality image displayed on a driver side image plane at a depth exterior of the vehicle. The primary augmented reality image generated on the driver side image plane is at a respective distance from the driver side window.

### BACKGROUND OF INVENTION

An embodiment relates to augmented reality side view displays.

Automobiles and other transportation vehicles include an interior passenger compartment in which the driver of the vehicle is disposed and operates vehicle controls therein. The vehicle typically includes rearview mirrors and side view mirrors for allowing the driver to monitor events occurring rearward and to the sides of the vehicle. A mirror is an object that reflects light in a way that for incident light in a respective range of wavelengths, the reflected light preserves much of the detailed physical characteristics of the original light and a reflection is generated that copies an original scene.

The rearview mirror and side view mirrors when properly set provide a cooperative viewing of events in back of and to the side of the vehicle. However, depending on how the mirrors are set, there may still be blind spots in which the driver cannot see. Moreover, side mirrors are not effective for viewing events during nighttime hours unless the road is properly illuminated.

In addition, side view mirrors create drag on the vehicle due to wind resistance, and therefore, lower the gas mileage of the vehicle. Precipitation buildup such as snow if not properly cleared off the side view mirror an effect the visibility of the mirror.

### SUMMARY OF INVENTION

An advantage of an embodiment is the display of an augmented reality image displaying a real world scene on a driver side view mirror by generating a virtual image of the real world scene. The generation of the augmented reality image utilizing a virtual image on an imaginary image plane eliminates the requirement for a physical side view mirror. Use of the augmented reality image eliminates the side view mirror component, which if mounted on the exterior of the vehicle causes wind resistance and drag thereby reducing fuel economy. In addition, since physical side mirror assemblies are not mounted on the exterior the vehicle, precipitation such as snow buildup on the mirror and reduce visibility of the real world scene. In addition, with the use of a camera system to capture the real world scene and display it via an augmented reality image, the field-of-view can be expanded thereby eliminating blind spots.

An embodiment contemplates a method of displaying augmented reality images as captured by a primary image capture device. Capturing an image exterior of a vehicle by the primary image capture device, the primary image capture device capturing an image of a driver side adjacent lane. Determining, by a processor, a size of the primary augmented reality image to be displayed to the driver. Generating a primary augmented reality image displayed on a driver side image plane at a depth exterior of the vehicle, the primary augmented reality image on the driver side image plane is generated at a respective distance from the driver side window.

### BRIEF DESCRIPTION OF DRAWINGS

FIG. 1 illustrates a block diagram of the augmented reality display system.

FIG. 2 plan view of a vehicle utilizing conventional side view mirrors.

FIG. 3 a plan view of a vehicle utilizing a camera system and regular image display or LCD display.

FIG. 4 illustrates the waveguide HUD mounted on a driver side window.

FIG. 5 is a plan view of a vehicle utilizing the augmented reality display system.

FIG. 6 is a flowchart for applying image processing for generating augmented reality images on a waveguide HUD.

### DETAILED DESCRIPTION

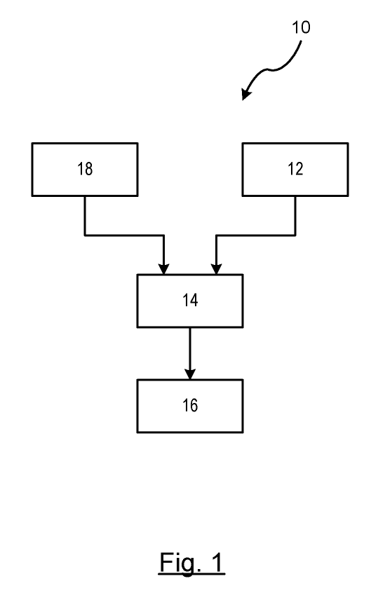

FIG. 1 illustrates a block diagram of the augmented reality display system 10 that includes an image capture device 12, a processor 14, a head up display (HUD) 16, and a head tracker 18. The HUD 16 can be either a holographic waveguide HUD attached to the side window or a head worn augmented reality display, which can utilize holographic waveguide technology or other HUD display technology. The system 10 generates an augmented reality display based on images captured by the image capture device 12. The vehicle as described herein eliminates the physical side view mirror assemblies mounted to an exterior of the vehicle. It should be understood that term vehicle as used herein is not limited to an automobile and may include, but is not limited to, trains, boats, or planes. Moreover, the HUD attached to the window or the head worn augmented reality display can be utilized by any passenger within the vehicle. This system can further be applied where autonomous or semi-autonomous driven vehicles are utilized where a driver is not required.

The image capture device 12 may include a camera or camera system that captures images exterior of the vehicle, and more specifically, images that the driver would be viewing through a side view mirror assembly. The image capture device may include, but is not limited to, a three dimensional (3D) camera or a stereo camera. Preferably, the image capture device captures 3D images or is capable of capturing images in 3D or providing images that can be processed into 3D images.

The mounting of the image capture device 12 can be mounted on the vehicle in a position that aligns the camera pose with the direction of the reflective ray that would be reflected from a side view mirror as seen by the driver. Alternatively, the image capture device 12 may be located at other locations of the vehicle and image processing is performed on the captured image to generate a virtual pose of the image capture device 12 which would generate an image that is displayed as if the image capture device 12 is mounted and aligned in a direction that would capture the real world scene similar to that displayed on the physical side view mirror assembly.

The processor 14 may be a standalone processor, a shared processor, or a processor that is part of an imaging system. The processor 14 receives the captured image from the image capture device 12 and performs image processing on the captured image. The processor 14 performs editing functions that includes, but are not limited to image clipping to modify the view as would be seen by a driver. If augmented reality glasses are worn, the processor also orients the image based on head orientation of the driver. The processor also, adjusts the luminance of the image, and compensates for image distortion.

The waveguide head up display (HUD) 16 is mounted to the vehicle component, such as the driver sidelight (e.g., driver side window or other window on the driver's side and/or a window on passenger's side). The driver's sidelight will be used herein for exemplary purposes, but a HUD may be mounted on any window for any person in the vehicle if so desired. The waveguide HUD 16 utilizes a holographic diffraction grating that attempts to concentrate the input energy in a respective diffraction order. An example of a diffraction grating may include a Bragg diffraction grating. Bragg diffraction occurs when light radiation with a wavelength comparable to atomic spacings is scattered in a specular pattern by the atoms of a crystalline system, thereby undergoing constructive interference. The grating is tuned to inject light into the waveguide at a critical angle. As light fans out, the light traverses the waveguide. When the scattered waves interfere constructively, the scattered waves remain in phase since the path length of each wave is equal to an integer multiple of the wavelength. The light is extracted by a second holographic diffraction grating that steers the light (e.g., image) into the user's eyes. A switchable Bragg Diffraction Grating may be utilized which includes grooved reflection gratings that give rise to constructive and destructive interference and dispersion from wavelets emanating from each groove edge. Alternatively, multilayer structures have an alternating index of refraction that results in constructive and destructive interference and dispersion of wavelets emanating from index discontinuity features. If one of the two alternating layers is comprised of a liquid crystal material having both dielectric and index of refraction anisotropy, then the liquid crystal orientation can be altered, or switched via an application of an electric field which is known as switchable Bragg Grating.

When the driver looks at the waveguide HUD 16 integrated on the window, the waveguide HUD 16 generates an augmented reality image on the imaginary plane based on the captured image that appears to be at a respective depth outside the window (i.e., either at a depth with the side view mirror would be located or at a further depth).

In an alternative solution, the waveguide HUD 16 may include a head worn HUD such as augmented reality glasses (e.g., spectacles). The 3D image is transmitted from the processor 14 to the 3D augmented reality glasses such that the augmented reality image is projected in space thereby providing the perspective that the image plane which the image is projected on is displayed at a location outside of the driver side window similar to that of an actual side view mirror.

The head tracker 18 is a device for tracking the head orientation or tracking the eyes. That is, if fewer details are required, then the augmented reality system 10 may utilize a head tracking system which tracks an orientation of the head for determining a direction that the driver is viewing. Alternatively, the augmented reality system 10 may utilize an eye tracking system where the direction (e.g., gaze of the eyes) are tracked for determining whether the occupant is looking in the direction of the waveguide HUD 16 or elsewhere. The head tracker 18 may be a standalone device mounted in the vehicle the monitors either the location of the head or the gaze of the eyes, or the head tracker 18 may also be integrated with the waveguide HUD 16 if augmented reality glasses are utilized. If augmented reality glasses are utilized, then an eye tracker would be integrated as part of the spectacles for tracking movements of the eye.

In addition to the waveguide HUD 16, a dye doped Polymer Dispersed Liquid Crystal (PDLC) is provided as a backer to the exit hologram to block real world interference. The PDLC blocks out light from other real-world interferences such that there are no emissions. The PDLC is tunable and can also be incorporated as an automatic tunable transmission. Therefore, the PDLC functions as a backer such that emissions from the exterior do not penetrate the opposite side of the hologram image when the driver is viewing the hologram image.

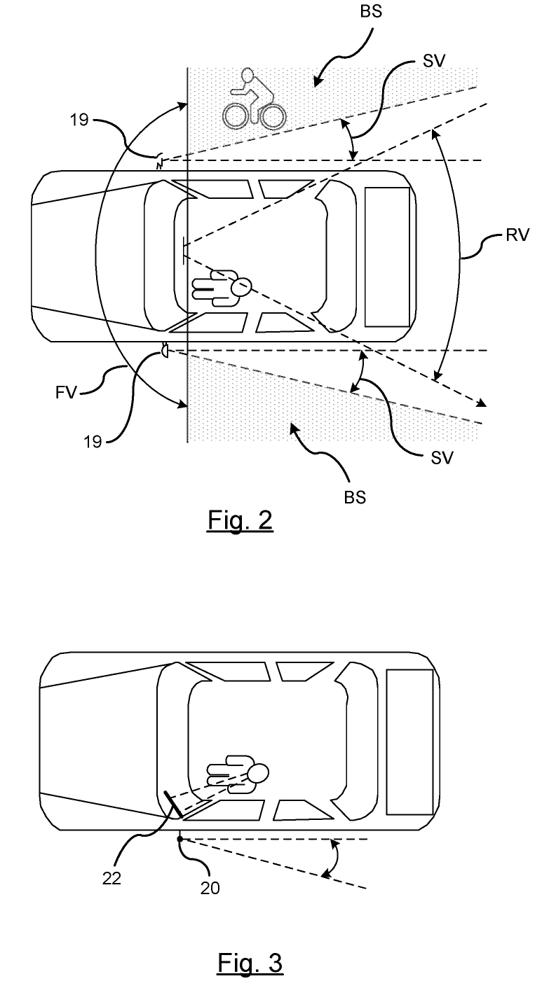

FIG. 2 illustrates a plan view of a vehicle utilizing conventional side view mirrors. As shown in FIG. 2, a region represented generally by RV represents the rearview mirror vision. A region represented generally by SV represents side view mirror vision. A region represented generally by BS (shaded region) represents blind spots. Blind spots are typically located in a region rearward of the driver's forward vision represented generally by FV to a location where the where reflections are captured by the side view mirrors 19. While blind spots can be reduced with the assistance of convex-shaped mirror, convex-shaped mirrors results in distortion to the actual real world scene causing objects to be closer or further in the reflective surface than that which is typically scene by the driver.

FIG. 3 illustrates a plan view of a vehicle utilizing a camera system and regular image display or LCD display. A single camera 20 is mounted on the exterior of the vehicle and the image captured by the camera 20 is processed and provided to a display device 22, such as an LCD monitor or similar. The advantage of utilizing the camera 20 is the elimination of side view mirrors which provides the advantage of eliminating drag on the vehicle caused by wind resistance, however, an issue with the single camera 20 and LCD 22 is that the system is two-dimensional (2D) and the proximity from the driver's eye to the LCD 22 is relatively short (e.g., 18 inches) which caused fatigue as a result of re-accommodating the display at 18 inches and the real world at infinity. Diminishing depth perception is present when presenting a camera image on to a 2D display. Also, the displayed image is not at the location of a traditional mirror. Being in the driver's visual field will lead to distraction.

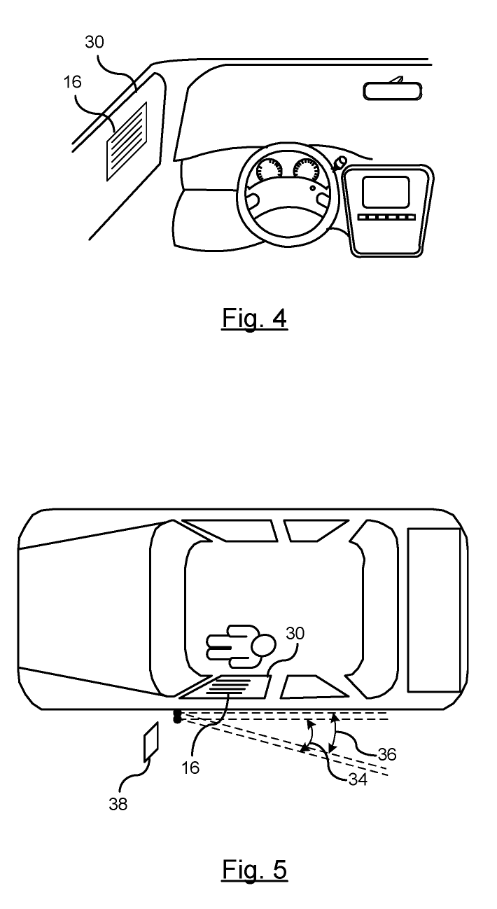

FIG. 4 illustrates the waveguide HUD 16 mounted on a vehicle component such the driver side window 30. A driver viewing through the driver side window 30 sees a 3D image of a real world scene captured by the image capture device which is projected on an imaginary plane outside the vehicle. The term real world scene as used herein and in the claims is defined as a region exterior of the vehicle as seen by the driver of the vehicle as seen directly or through a mirror reflection. The image capture device 12 can be mounted and aligned in a same direction that the reflective rays would be reflected by a side view mirror, or the image capture devices 12 may be mounted in other locations and image processing may be used to change the pose of the camera. That is, a scene can be captured from any angle, however, the image may be processed such that a virtual pose is identified in the image is altered to reflect the contents of the scene is if the camera was in alignment with the virtual pose.

In addition, by utilizing the image capture devices, a field-of-view (FOV) as captured by the image capture device can be altered to make the FOV wider in comparison to a conventional side view mirror display. The FOV can be altered up to 180° and various portions of the image can be zoomed (synthesized) to enhance the driver's focus on a respective portion of the image.

The waveguide HUD 16 uses an imaginary plane to display the augmented reality image. The waveguide HUD 16 can be tuned to set the imaginary plane at any distance outside the window to infinity. It should be understood that there is relatively small substantial distinction in a perception in the focal length of a person viewing an object once the object distance is between 3 meters and infinity. The depth at which the imaginary plane is set is tunable.

FIG. 5 illustrates a plan view of a vehicle utilizing the augmented reality display system. As shown in FIG. 5, the augmented reality system utilizes two image capture devices 12 (e.g., stereo cameras) for capturing a 3-D real world scene of a driver's adjacent lane. Preferably, the image capture devices are stereo vision cameras; however, it should be understood that other types of 3-D image capture devices may be utilized. As shown in FIG. 5, a first region 34 is of the adjacent road is captured by one of the image capture devices and a second region 36 is captured by a second image capture device. The two captured images are processed to generate a 3-D image. The processor processes the images and transmits the processed image to the waveguide HUD 16 integrated on the driver side window 30. The waveguide HUD 16 generates the augmented reality image) on a virtual plane 38 that appears exterior of the vehicle. As a result, the augmented reality image eliminates the requirement using a physical component mounted on the door (i.e., side view mirror) which causes drag on the vehicle and reduces fuel economy.

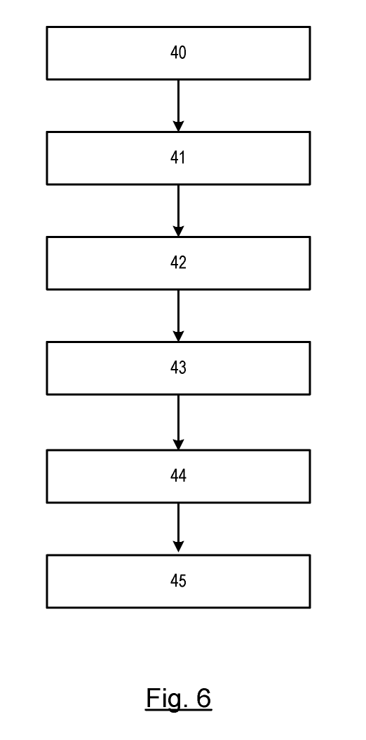

FIG. 6 represents a flowchart of applying image processing for generating augmented reality images of the object on the waveguide HUD that is mounted on the side window. In block 40, images are captured by the image capture device. The image may be 2D or 3D images from a 3D camera or a set of stereo cameras may capture the image for generating a 3D image.

In block 41, if augmented reality glasses are utilized, then the image is clipped to accommodate the field of view of the augmented reality glasses.

In step 42, image perspective and stabilization is applied. Devices including, but not limited to, a gyroscope and accelerometers may be used to determine an orientation of the driver's head. The gyroscope and accelerometers maintain stable and aligned images as the head is rotated. Examples of tracking systems may include a head tracker, which monitors movements of the head in the direction that the head is facing. More complex devices and systems would include a gaze tracker which tracks movements of the eyes for determining the direction that the eyes are looking. A gaze tracker provides more details such that the driver may not necessarily move his head, but may rotate his eyes without movement of the head to look away from the road of travel.

In step 43, view port narrowing is applied. A size of the view port to be narrowed is determined by a size of the conventional mirror or larger, and also the distance to the imaginary plane outside the side window is determined for sizing the image accordingly.

In step 44, a luminance of the augmented reality image is adjusted. A luminance sensor may be used to control 3D image luminance. It should be understood that the luminance may be set higher relative to that of the real world scene during nighttime conditions such that objects captured in the image are identifiable. This is advantageous over conventional side view mirrors where the mirror can only capture the light illuminated from the external environment and is therefore bound by the exterior conditions. By utilizing the images captured by image capture device, image processing may be performed to illuminate the scene, and therefore, provide better visibility of the scene to the driver.

In step 45, the virtual image is displayed via the HUD. The virtual image would be sized according to a shape and size of the side view mirror as typically seen by the driver looking through the driver or passenger sidelight (or a passenger looking through another sidelight window) or the display may be larger than a conventional mirror. Furthermore, the virtual image may be displayed at a greater distance than what a driver would view with a conventional mirror.

While certain embodiments of the present invention have been described in detail, those familiar with the art to which this invention relates will recognize various alternative designs and embodiments for practicing the invention as defined by the following claims.

What is claimed is:

1. A method of displaying augmented reality images as captured by a primary image capture device, the method comprising the steps of:
capturing an image exterior of a vehicle by the primary image capture device, the primary image capture device capturing an image of a driver side adjacent lane;
determining, by a processor, a size of the primary augmented reality image to be displayed to a driver;
generating a primary augmented reality image displayed on a driver side image plane at a depth exterior of the vehicle, the primary augmented reality image on the driver side image plane is generated at a respective distance from the driver side window.

2. The method of claim 1 further comprising the step of capturing a secondary image exterior of a vehicle by a secondary image capture device, the secondary image capture device capturing the secondary image of a passenger's side adjacent lane;
determining, by a processor, a size of the secondary augmented reality image to be displayed to the driver;
generating the secondary augmented reality image displayed on an passenger side image plane at a depth exterior of the vehicle, the secondary augmented reality image on the passenger side image plane is generated at a respective distance from the passenger side window.

3. The method of claim 2 further comprising the step of adjusting a luminance of the primary and secondary augmented reality images using a luminance sensor to illuminate a real world scene captured by the primary and secondary image capture devices.

4. The method of claim 2 wherein the augmented reality image is narrowed for sizing the primary and secondary augmented reality images to at least a size and shape of a conventional side view mirror.

5. The method of claim 2 further comprising the step of clipping the primary and secondary augmented reality images, the clipped primary and secondary augmented reality images representative of a field-of-view of a conventional side view mirror from the driver's perspective.

6. The method of claim 2 wherein a driver side waveguide head up display (HUD) is mounted on the driver side window to generate the augmented reality image exterior of the vehicle.

7. The method of claim 6 wherein a passenger side waveguide head up display (HUD) is mounted on the passenger side window to generate the augmented reality image exterior of the vehicle.

8. The method of claim 7 wherein the driver and passenger side waveguide HUDs each include a dye doped backer crystal mounted to a back of the driver and passenger side waveguide HUDs, wherein real world emissions are blocked from entering the driver and passenger side waveguide HUDs as a result of the dye doped backer crystal.

9. The method of claim 8 further comprising the step of tuning a transmission of the dye doped backer crystal.

10. The method of claim 6 wherein the driver and passenger side waveguide HUDs apply a Bragg diffraction grating to generate the augmented reality images exterior of the vehicle.

11. The method of claim 6 wherein the driver and passenger side waveguide HUDs apply a switchable Bragg diffraction grating to generate the augmented reality images exterior of the vehicle.

12. The method of claim 2 further comprising the step of applying head tracking to determine an orientation of a driver's head.

13. The method of claim 2 further comprising the step of applying eye tracking for determining a viewing perspective of the driver.

14. The method of claim 13 wherein eye tracking is applied to determine respective distances from a driver's eye to the driver side window and the passenger side window.

15. The method of claim 2 further comprising the steps of:
determining a gaze of the driver;
determining whether the gaze of the driver is directed at the driver or passenger side image plane for greater than a predetermined period of time.

16. The method of claim 15 further comprising the step of generating the primary augmented reality image on the driver side image plane in response to the gaze of the driver being directed at the driver side image plane for greater than the predetermined period of time.

17. The method of claim 16 further comprising the step of inhibiting the reality augmented image from being displayed in response to the gaze of the driver being directed at the driver side waveguide image plane for less than the predetermined period of time.

18. The method of claim 15 further comprising the step of generating the secondary augmented reality image on the passenger side image plane in response to the gaze of the driver being directed at the passenger side image plane for greater than the predetermined period of time.

19. The method of claim 18 further comprising the step of inhibiting the reality augmented image from being displayed in response to the gaze of the driver being directed at the passenger side image plane for less than the predetermined period of time.

20. The method of claim 2 wherein the primary and secondary augmented images are generated by the spectacles.

21. The method of claim 20 further comprising the step of applying image perspective and stabilization to the primary and secondary augmented reality images generated by the by the spectacles.

22. The method of claim 21 wherein image perspective and stabilization is applied by a gyroscope mounted on the spectacles.

23. The method of claim 21 wherein image perspective and stabilization is applied by at least one accelerometer mounted on the spectacles.

24. A method of displaying augmented reality images as captured by a primary image capture device, the method comprising the steps of:
capturing an image exterior of a vehicle by the primary image capture device, the primary image capture device capturing an image of a driver side adjacent lane;
determining, by a processor, a size of the primary augmented reality image to be displayed to a person with the vehicle;
generating a primary augmented reality image displayed on a driver side image plane at a depth exterior of the vehicle, the primary augmented reality image on the driver side image plane is generated at a respective distance from the driver side window.

25. The method of claim 24 further comprising the step of capturing a secondary image exterior of a vehicle by a secondary image capture device, the secondary image capture device capturing the secondary image of a passenger's side adjacent lane;
determining, by a processor, a size of the secondary augmented reality image to be displayed to the person within the vehicle;
generating the secondary augmented reality image displayed on an passenger side image plane at a depth exterior of the vehicle, the secondary augmented reality image on the passenger side image plane is generated at a respective distance from the passenger side window.

26. The method of claim 25 wherein the person within the vehicle is seated in a driver's seat.

27. The method of claim 25 wherein the person is seated within the vehicle is in a seat other than the driver's seat.
